(19) United States
(12) Patent Application Publication
(10) Pub. No.: US 2011/0316918 A1
(43) Pub. Date: Dec. 29, 2011

(54) LIQUID EJECTION HEAD, LIQUID EJECTION APPARATUS AND INKJET PRINTING APPARATUS

(76) Inventor: Kanji NAGASHIMA, Kanagawa-ken (JP)

(21) Appl. No.: 13/171,173

(22) Filed: Jun. 28, 2011

(30) Foreign Application Priority Data
Jun. 29, 2010 (JP) 2010-147888

(51) Int. Cl. B41J 29/38

(52) U.S. Cl. 347/12

(57) ABSTRACT

A liquid ejection head has a recording element including a set of ejection elements. Each of the ejection elements includes a pressure chamber, a supply flow channel connected to the pressure chamber, an ejection energy generating device arranged correspondingly to the pressure chamber, and an ejection port connected to the pressure chamber. The ejection elements constituting the same set have identical ejection operation characteristics. The ejection energy generating devices included in the ejection elements constituting the same set are connected to a common signal wire, and are configured to be applied with the same drive signal through the common signal wire to be simultaneously driven. In the ejection elements constituting the same set, when the ejection energy generating devices are simultaneously driven, liquids are ejected from the pressure chambers through the ejection ports and deposited to a same pixel on an image formation medium in an image formation operation.

### BACKGROUND OF THE INVENTION

1. Field of the Invention

The present invention relates to a liquid ejection head, and more particularly to a structure of a head which ejects droplets by an inkjet method, and to a liquid ejection apparatus and an inkjet printing apparatus using such a head.

2. Description of the Related Art

Japanese Patent Application Publication No. 2005-035271 discloses a composition in which ink droplets ejected respectively from two ink ejection units are made to collide and combine with each other in flight and the combined droplet is deposited onto a recording medium, with the aim of printing an image of high resolution at high speed. These two ink ejection units have mutually separate (independent) pressure chambers and piezoelectric actuators, and the ejection timing and number of ejected ink droplets of each ejection unit is controlled. Japanese Patent Application Publication No. 06-071902 discloses technology similar to that of Japanese Patent Application Publication No. 2005-035271.

Japanese Patent Application Publication Nos. 2005-035271 and 06-071902 disclose a method of forming one pixel by ejecting droplets respectively from nozzles connected to a plurality of pressure chambers. However, since these compositions include individual actuators for the respective pressure chambers, and the driving of each actuator is independently controlled, then the drive control system of the actuators becomes complicated, costs are high and this presents an obstacle to increased density.

WO 01/08888 and Japanese Patent Application Publication No. 2008-023793 disclose a head structure which circulates ink inside chambers (pressure chambers) connected to nozzles.

WO 01/08888 discloses technology relating to ink circulation for ensuring ejection stability over a long period of time, but makes no mention of application to a head composition which forms one pixel on a recording medium by means of droplets separately ejected from respective nozzles of a plurality of pressure chambers.

Japanese Patent Application Publication No. 2008-023793 provides technology having a main objective of controlling the ejection direction of droplets (deflection of flight); a plurality of pressure chambers have different resonances and deflection is performed by changing the drive pulse width. In Japanese Patent Application Publication No. 2008-023793, similarly to Japanese Patent Application Publication Nos. 2005-035271 and 06-071902, the control system for driving the actuators which are arranged integrally with respective pressure chambers is complicated. Japanese Patent Application Publication No. 2008-023793 does not provide technology for ejecting large ink droplets using a simple control system. Furthermore, in a composition which forms one pixel by means of droplets ejected from a plurality of nozzles, there is a concern with regard to deviation in the ejection direction due to manufacturing variations in the head, but no composition for suppressing this is disclosed.

### SUMMARY OF THE INVENTION

The present invention has been contrived in view of these circumstances, an object thereof being to provide a liquid ejection head capable of ejecting large droplets at a high frequency, by means of a simple drive control system. Moreover, in realizing a head of this kind, it is an object to prevent the drive circuit from becoming complicated and to prevent the flow channel structure for supplying and circulating ink from becoming complicated. Furthermore, in a head composition of this kind, it is an object to prevent decline in the ejection direction accuracy as a result of manufacturing variations.

In order to attain the aforementioned object, the present invention is directed to a liquid ejection head, comprising: a plurality of pressure chambers which are each filled with liquids; a plurality of supply flow channels which are connected respectively to the pressure chambers, the liquids being supplied through the supply flow channels to the pressure chambers; a plurality of ejection energy generating devices which are arranged correspondingly to the pressure chambers, the ejection energy generating devices being driven by a drive signal to generate ejection force; and a plurality of ejection ports which are connected respectively to the pressure chambers, the liquids in the pressure chambers being ejected outward through the ejection ports by the ejection force generated by the corresponding ejection energy generating devices, wherein: the liquid ejection head has a recording element including a set of ejection elements; each of the ejection elements includes one of the pressure chambers, one of the supply flow channels which is connected to the one of the pressure chambers, one of the ejection energy generating devices which is arranged correspondingly to the one of the pressure chambers, and one of the ejection ports which is connected to the one of the pressure chambers; the ejection elements constituting the same set have identical ejection operation characteristics; the ejection energy generating devices included in the ejection elements constituting the same set are connected to a common signal wire, and are configured to be applied with the same drive signal through the common signal wire to be simultaneously driven; and in the ejection elements constituting the same set, when the ejection energy generating devices are simultaneously driven, the liquids are ejected through the ejection ports and deposited to a same pixel on an image formation medium in an image formation operation.

According to this aspect of the present invention, recording of the same pixel (dot formation at the same pixel position) is performed by the plurality of ejection elements having matching characteristics. The ejection elements constituting a set which record the same pixel are driven simultaneously by the common drive signal, and the liquids are ejected from the respective ejection elements. By this means, it is possible to form a dot having a large coverage surface area by means of an aggregation of the liquids ejected from the plurality of ejection elements. While being able to increase the total volume of the droplets ejected from the ejection elements constituting the set (the ejected droplet volume of the set unit), it is also possible to design each ejection element with a relatively small size of pressure chamber and ejection can be performed at a high frequency.

The “ejection energy generating device” may employ a mode using a piezoelectric body (a piezoelectric jet method), or a mode using an electrostatic actuator, or a mode using a heat generating element (heater) in a thermal jet method, or the like.

Reference to the ejection operation characteristics being “identical” means “identical” in design terms, and slight differences which occur with the range of manufacturing error or variation are within the range of “identical”. Even if precise “identical” cannot be guaranteed between ejection elements in actual practice, due to the processing accuracy or manufacturing variations, provided that there is no intention to generate clear differences between the ejection elements in the design concept, and provided that any differences are in a range which can be treated as substantially “identical” without causing any problems, then the ejection elements are regarded as having the “identical ejection operation characteristics”.

This aspect of the present invention is particularly valuable when applied to a drop-on-demand (DOD) type of liquid ejection head which controls driving of ejection energy generating devices in accordance with image data that is to be formed.

Preferably, the pressure chambers included in the ejection elements constituting the same set are supplied with the liquids having identical composition.

According to this aspect of the present invention, the present invention is applied to a mode where recording of the same pixel is performed by ejecting the liquid of the same composition (for example, liquid of the same properties, such as ink of the same color), from the plurality of ejection elements.

Preferably, the ejection energy generating devices each include actuators configured to change volume of the corresponding pressure chambers; and the actuators included in the ejection energy generating devices included in the ejection elements constituting the same set have identical excluding volume.

According to this aspect of the present invention, the ejection energy generating devices in the ejection elements constituting the same set generate mutually equal ejection energies.

Preferably, the pressure chambers included in the ejection elements constituting the same set have an identical resonance frequency.

The resonance frequency of the pressure chambers is the intrinsic vibration frequency (Helmholtz frequency) of the whole vibration system which is determined by the dimensions, material and physical values, and the like, of the liquid flow channel system, the liquid (acoustic element), and the actuator.

Preferably, the pressure chambers included in the ejection elements constituting the same set are connected to each other through a joint flow channel.

According to this aspect of the present invention, the liquids can move between the pressure chambers through the joint flow channel. By adopting this composition, it is possible to circulate the liquid between the ejection elements constituting the same set, and the number of circulation flow channels and supply flow channels can be reduced.

Preferably, in each of the pressure chambers in plan view, a portion to which the supply flow channel is connected and a portion to which the joint flow channel is connected are arranged at substantially diagonally opposite positions or at positions distanced furthest apart.

According to this aspect of the present invention, stagnation is not liable to occur inside the pressure chambers and the liquids inside the pressure chambers can be circulated efficiently.

Preferably, in the ejection elements constituting the same set, at least one of the supply flow channels connected to the pressure chambers is configured to also serve as a circulation flow channel through which the liquids inside the pressure chambers are circulated while no ejection operation is performed.

According to this aspect of the present invention, the liquid is moved from the supply flow channel to the circulation flow channel, thereby circulating the liquid inside the pressure chambers, when no ejection operation is performed. During ejection, the liquid is supplied from also the circulation flow channel side to the pressure chamber and the circulation flow channel also serves as a supply flow channel.

Preferably, in the ejection elements constituting the same set, at least two of the ejection ports are arranged side by side along a direction parallel to a relative movement direction in which the liquid ejection head and the image formation medium are moved relatively to each other during the image formation operation.

According to this aspect of the present invention, even if there is flight deflection in the same direction as the relative movement direction of the image formation medium and the head, this is not readily visible as stripe-shaped non-uniformity (white stripes or striped-shaped density variation).

Preferably, each of the ejection ports has one of a circular shape, an elliptical shape, a semi-circular shape, a semi-elliptical shape obtained by cutting an ellipse along a minor axis thereof, and a quadrilateral shape.

As in this aspect of the present invention, various modes are possible for the opening shape of the ejection port.

Preferably, meniscuses of the liquids are formed respectively in the ejection ports.

According to this aspect of the present invention, the droplets ejected from the respective ejection ports combine together (unite) during flight or on the image formation medium, and form a dot corresponding to one pixel.

It is also preferable that the recording element further includes a nozzle section; the ejection ports included in the ejection elements constituting the same set are arranged inside the same nozzle section; and in the ejection elements constituting the same set, when the ejection energy generating devices are simultaneously driven, droplets of the liquids are ejected through the ejection ports and then combine together in the same nozzle section to be ejected outward through the same nozzle section as a combined droplet.

According to this aspect of the present invention, the flow channels are formed separately until the position of the ejection ports of the ejection elements, but are joined into one nozzle aperture in the nozzle section. By this means, the liquids ejected from the respective ejection ports are ejected as a single body (combined body) from the outlet of the nozzle section.

Preferably, in the ejection elements constituting the same set, when the ejection energy generating devices are simultaneously driven, the liquids are ejected outward through the ejection ports, then combine together before arriving at the image formation medium, and then land on the image formation medium.

The liquid volume is the same in a case where the droplets combine before landing on the image formation medium and a case where the droplets combine after landing on the image formation medium, but the size of the dot formed on the image formation medium (the coverage surface area) differs. According to this aspect of the present invention, by making the droplets combine with each other before landing and then landing on the image formation medium in the form of the combined droplet, it is possible to form a dot having a larger coverage surface area, compared to a case where the droplets combine on the image formation medium.

Preferably, in the ejection elements constituting the same set: a number of the ejection elements is two; and an arrangement of the two ejection elements is one of mirror symmetrical and rotationally symmetrical.

It is also preferable that in the ejection elements constituting the same set: a number of the ejection elements is at least three; and an arrangement of the at least three ejection elements is rotationally symmetrical.

It is also preferable that in the ejection elements constituting the same set: a number of the ejection elements is an even number not less than four; an arrangement of at least two of the ejection elements is rotationally symmetrical; and an arrangement of at least two of the ejection elements is mirror symmetrical.

According to these aspects of the present invention, by means of the symmetrical structure, it is possible to match the ejection characteristics (ejection operation characteristics) of the respective ejection elements.

Preferably, the recording element further includes a partition member across which two of the pressure chambers included in the ejection elements constituting the same set adjoin each other; and at least portion of the partition member is configured to deform when the ejection force is applied by at least one of the ejection energy generating devices corresponding to the two of the pressure chambers.

According to this aspect of the present invention, when an ejection pressure difference (pressure difference) occurs between the ejection elements constituting the same set, due to manufacturing error, or the like, the pressure difference is absorbed by deformation of the partition member. In this composition, the displacement halts when the pressures on either side of the partition member are balanced, and hence it is possible match the ejection characteristics of the respective ejection elements. By this means, the accuracy of the ejection direction is improved.

Preferably, the at least portion of the partition member has a pleat-shaped bent section.

According to this aspect of the present invention, by adopting a composition having a bent section in which a portion of the partition member is folded like a bellows, for example, it is possible to achieve the partition member which deforms flexibly due to pressure difference during ejection.

Preferably, the ejection energy generating devices each include actuators having piezoelectric bodies; and the piezoelectric bodies are divided from each other for the pressure chambers.

According to this aspect of the present invention, it is possible to reduce cross-talk between the pressure chambers.

It is also preferable that the ejection energy generating devices each include actuators having piezoelectric bodies; and the piezoelectric bodies of the actuators included in the ejection elements constituting the same set are connected to each other.

According to this aspect of the present invention, the surface area of the end face portions of the piezoelectric bodies which are exposed is reduced and the occurrence of insulation breakdown due to deterioration over time is reduced in comparison with the composition where the piezoelectric bodies are divided from each other for the pressure chambers. By this means, an advantage is obtained in terms of longer life span. Furthermore, during manufacture, the number of processing steps for patterning the piezoelectric bodies is reduced and the manufacturing process can be simplified.

Preferably, a flow channel part including the pressure chambers and the supply flow channels is formed in a silicon substrate.

According to this aspect of the present invention, it is possible to perform highly accurate fine processing by using semiconductor manufacturing technology.

In order to attain the aforementioned object, the present invention is also directed to a liquid ejection apparatus, comprising: the liquid ejection head as described above; and a drive control circuit which controls an ejection operation of the liquid ejection head by generating the drive signal applied to each of the ejection energy generating devices, wherein a waveform of the drive signal is configured to accelerate a speed of flight of a satellite droplet compared to a speed of flight of a main droplet in such a manner that the satellite droplet and the main droplet combine together during the flight, the main droplet being formed of the liquid ejected first by an ejection operation, the satellite droplet being formed of the liquid ejected following the liquid forming the main droplet.

According to this aspect of the present invention, by accelerating the droplet speed of the satellite droplet which occurs after the main droplet, the satellite droplet catches up with and combines with the main droplet preceding it. A large dot is formed on the image formation medium by this combined droplet.

Preferably, the waveform of the drive signal has a waveform element configured to drive each of the ejection energy generating devices in a direction to push out the liquid when the liquid that is separated from a meniscus as the satellite droplet passes near the ejection ports.

According to this aspect of the present invention, by applying further pressure by the ejection energy generating device at a timing when the satellite droplet is to exit from the ejection port, it is possible to increase the speed of the satellite droplet. Consequently, the satellite droplet can be made to combine reliably with the main droplet.

In order to attain the aforementioned object, the present invention is also directed to an inkjet printing apparatus which uses the liquid ejection head as described above or the liquid ejection apparatus as described above.

As an example of the composition of a print head (recording head) used in the inkjet printing apparatus, it is possible to use a full-line type head having a nozzle row in which a plurality of ejection ports (nozzles) are arranged through a length of no less than the full width of the image formation medium, by joining together a plurality of head modules. A full line type head of this kind is normally arranged in a direction perpendicular to the relative feed direction of the image formation medium (paper) (the relative conveyance direction), but a mode is also possible in which a head is arranged in an oblique direction forming a certain prescribed angle with respect to the direction perpendicular to the conveyance direction.

The “image formation medium” is a medium which receives deposition of droplets ejected from ejection ports of the head (the medium may also be called a print medium, an image formation medium, a recording medium, an image receiving medium, an ejection receiving medium, or the like), and includes various media regardless of material or shape, such as continuous paper, cut paper, sealed paper, resin sheet, such as OHP sheet, film, cloth, a printed substrate on which a wiring pattern, or the like, is formed, an intermediate transfer medium, or the like.

The conveyance device which moves the image formation medium and the head relatively also includes a mode which conveys an image formation medium with respect to a stationary (fixed) head, a mode which moves a head with respect to a stationary image formation medium, or a mode which moves both a head and an image formation medium. If forming a color image by using a print head based on an inkjet method, it is possible to arrange heads for each color of ink (recording liquid) of a plurality of colors, or to adopt a composition where inks of a plurality of colors can be ejected from one recording head.

According to the present invention, it is possible to obtain a large ejection volume by aggregating a plurality of droplets ejected from a plurality of ejection elements having matching characteristics, and a dot having a large coverage surface area can be formed on an image formation medium. Moreover, it is possible to perform ejection at the ejection frequency achieved by the respective ejection elements, and hence a large ejection volume can be ejected at a high frequency. Furthermore, a common signal wire can be used to drive the respective ejection elements and the control system has a simple composition.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic drawing showing a composition of an inkjet head in the related art;

FIG. 2 is a schematic drawing investigating a head structure for increasing the ejection volume in the related art;

FIG. 3 is a schematic drawing showing a composition of an inkjet head according to an embodiment of the present invention;

FIG. 4 is a cross-sectional diagram of the inkjet head including a pair of ejection elements shown in FIG. 3;

FIGS. 5A to 5C are plan diagrams showing schematic views of arrangements of two ejection elements constituting a set;

FIGS. 6A to 6C are plan diagrams showing schematic views of arrangements of three or more ejection elements constituting a set;

FIGS. 7A and 7B are diagrams showing schematic views of shapes of the ejection ports of ejection elements;

FIGS. 8A to 8C are diagrams showing schematic views of shapes of the ejection ports of ejection elements;

FIG. 9 is a diagram showing a schematic view of a nozzle section connected to respective ejection ports of a plurality of ejection elements;

FIG. 10 is a cross-sectional diagram of a composition having a nozzle section for each ejection element;

FIG. 11 is a cross-sectional diagram of a composition having a single nozzle section connected to respective ejection ports of a plurality of ejection elements;

FIG. 12 is an illustrative diagram of a case where one of the ejection elements constituting a set is suffering an ejection failure;

FIG. 13 is an illustrative diagram of a composition where a partition of a pressure chambers constituting a set is movable;

FIG. 14 is an enlarged diagram showing the composition of the movable partition shown in FIG. 13;

FIG. 15 is a waveform diagram showing a drive waveform;

FIG. 16 is a schematic drawing of an inkjet printing apparatus according to an embodiment of the present invention; and

FIG. 17 is a block diagram showing the composition of a control system of the inkjet printing apparatus shown in FIG. 16.

### DETAILED DESCRIPTION OF THE PREFERRED EMBODIMENTS

Here, an inkjet head using piezoelectric actuators is described as an example, but the present invention can also be applied to heads of various types, such as inkjet heads using electrostatic actuators, heat-generating elements (heaters), or the like, as ejection energy generating elements. Furthermore, the present invention may also be applied to either a drop-on-demand type of head or a continuous-ejection type of head. In particular, the present invention is suitable for a head based on a method for ejecting ink by using resonance, as in an inkjet head using piezoelectric actuators.

### Composition in the Related Art and Classification of Technical Issues

Before describing embodiments of the present invention, firstly, the composition of an inkjet head in the related art is described and the technical issues relating thereto are classified below.

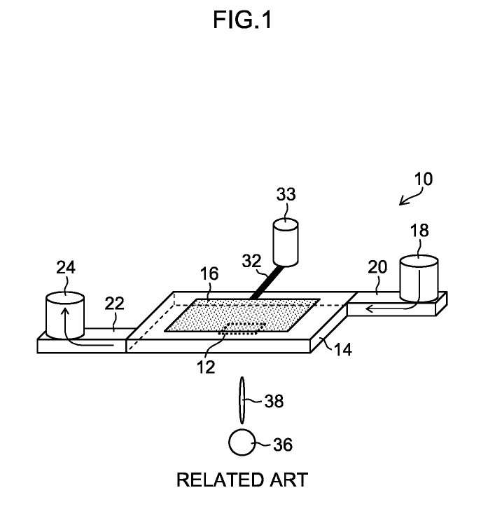

FIG. 1 is a diagram showing a schematic view of a composition of an inkjet head in the related art using piezoelectric actuators. In order to simplify the drawing in FIG. 1, a flow channel portion through which ink flows is depicted as a simplified composition of one ejection element which performs recording of one pixel, with only the outer shape of the flow channel being depicted. The ejection element 10 shown in FIG. 1 includes: a nozzle 12, which serves as an ink ejection port; a pressure chamber 14, which stores the ink; a piezoelectric actuator 16, which applies an ejection force to the ink in the pressure chamber 14; an ink inlet port 18 and a supply flow channel 20, through which the ink is supplied to the pressure chamber 14; and a circulation flow channel 22 and an ink outlet port 24, through which the ink inside the pressure chamber 14 is circulated. An upper electrode of the piezoelectric actuator 16 is connected to a drive circuit (ASIC) (not shown) through a wiring electrode 32 and a signal wire 33.

The ink inlet port 18 is connected to an ink tank (not shown) through a flow channel (not shown), and the ink which has flown in through the ink inlet port 18 fills into the pressure chamber 14 through the supply flow channel 20. By applying a drive voltage to the piezoelectric actuator 16 from the drive circuit (not shown) through the signal wire 33 and the wiring electrode 32, the piezoelectric actuator 16 is displaced, and the volume of the pressure chamber 14 is changed, thereby causing an ink droplet 36 to be ejected from the nozzle 12. A satellite droplet 38 separated from the meniscus is generated after the main droplet 36.

The circulation flow channel 22 is connected to the pressure chamber 14, and the ink inside the pressure chamber 14 (the ink that has not been used for ejection) flows through the circulation flow channel 22 and exits from the ink outlet port 24. The ink outlet port 24 is connected to a recovery tank (not shown) through a flow channel (not shown), whereby an ink circulation channel is formed. By circulating the ink inside the pressure chamber 14 in this way, it is possible to always supply fresh ink to the pressure chamber 14, and increase in the viscosity of the ink can be prevented. Thus, it is possible to achieve stable ejection over a long period of time.

A suitable pressure differential is provided between the flow channels of the ink inlet port 18 and the ink outlet port 24, and when ejection is not performed, the ink enters into the pressure chamber 14 from the supply flow channel 20, and the ink then flows slowly so as to exit to the circulation flow channel 22. The speed at which the ink flows due to the pressure differential in the circulation system is sufficiently slow compared to the speed (ejection cycle) at which droplets of the ink are ejected during an ejection operation (during printing), and the speed at which the ink is ejected (the ink exiting from the nozzle) is faster. Consequently, when performing a continuous ejection operation, the flow of ink toward the ink outlet port 24 becomes slow, and the ink ultimately flows into the pressure chamber 14 from both sides, in other words, from the circulation flow channel 22 as well. Thus, the circulation flow channel 22 also functions as a supply flow channel of the ink during the ejection operation.

By optimizing the design parameters in the composition such as that shown in FIG. 1, it is possible to stably eject droplets, each having the volume of 3 picoliters (pl), for example, at a frequency of 150 kHz. However, in the present circumstances, this is the approximate limit of the optimization of head design. For example, in order to eject droplets of 6 pl each, which is twice the droplet volume described above, at a frequency of 150 kHz, it is simply necessary to double the displacement of the piezoelectric actuator, and an extremely high drive voltage must be applied, and therefore practical application is difficult.

Moreover, supposing that it is possible to eject 6 pl droplets, the droplet speed becomes faster, and if the same nozzle as for 3 pl droplets is used, then the droplet speed becomes twice as fast, an ink mist is liable to occur, and it becomes difficult to perform stable ejection. On the other hand, if the nozzle diameter is made larger, the droplet speed can be lowered, but the resonance frequency of the pressure chambers becomes low, and then it becomes impossible to perform ejection at 150 kHz.

In general, in the inkjet head using piezoelectric actuators, ink is ejected by utilizing the resonance of the pressure chambers, and therefore in order to eject the ink at high frequency, the pressure chambers must have a high resonance frequency in proportion to the ejection frequency.

Moreover, if the nozzle diameter is large, then the refilling properties after ejection of ink decline, and continuous ejection becomes difficult. Refilling of ink is performed by vibration which is excited by the surface tension of the meniscus surface formed in the nozzle, and this vibration has a higher frequency, the smaller the meniscus. In other words, the vibration period of the meniscus becomes shorter and refilling becomes faster, the smaller the nozzle diameter. Conversely, the vibration period of the meniscus becomes longer and refilling becomes slower, the larger the nozzle diameter.

Consequently, if large droplets are to be ejected stably and continuously at a high frequency in one ejection element, then there are incompatibilities with the head design parameters, and hence a problem occurs in that desired performance is difficult to achieve.

### <Investigation of Head Design for Increasing Droplet Volume>

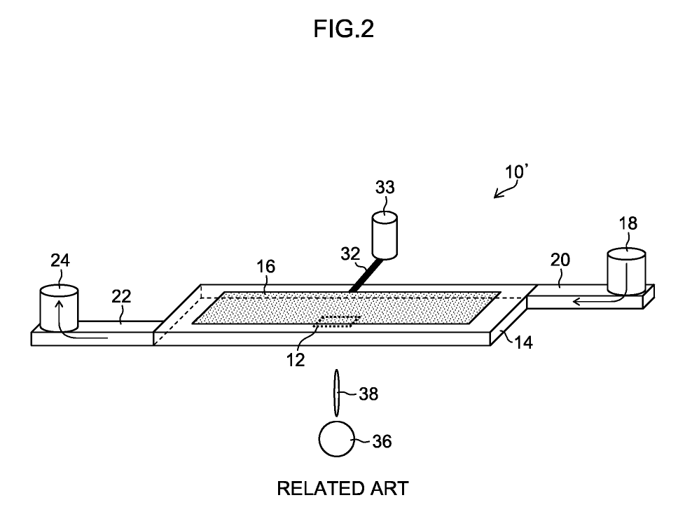

A composition for ejecting large droplets while maintaining a high value for the intrinsic vibration frequency (resonance frequency) of the pressure chamber was investigated. An ejection volume of 6 pl is achieved by basing the dimensions of the pressure chambers and nozzles, and the like, on the design of the inkjet head capable of ejecting 3 pl droplets at 150 kHz (shown in FIG. 1), and the design is changed where necessary in order to achieve as high a resonance frequency as possible, while ensuring that ink refilling is sufficiently fast and unwanted vibrations are suppressed during ejection. If it is sought to eject 6 pl droplets at a similar speed to 3 pl droplets, on the basis of this shape of head, then a head composition such as that shown in FIG. 2 is obtained. In FIG. 2, constituent elements which are the same as or similar to FIG. 1 are denoted with the same reference numerals and further explanation thereof is omitted here.

In the ejection element 10′ shown in FIG. 2, in order to make the excluded volume produced by the piezoelectric actuator 16 larger than in the ejection element 10 shown in FIG. 1, the pressure chamber 14 is broadened (by approximately twice compared to FIG. 1), and the surface area of the piezoelectric actuator 16 is increased (by approximately twice the surface area compared to FIG. 1). Moreover, the nozzle diameter is enlarged and the droplet speed is kept the same as when ejecting 3 pl droplets as in the ejection element 10 shown in FIG. 1. Furthermore, the resonance frequency is raised and the ink refilling speed is raised, by altering the size (cross-sectional area and length) of the supply flow channel 20 and the circulation flow channel 22 to vary the resistance and inertance of the flow channels, and an appropriate balance between these values is achieved in order to apply suitable damping to rapidly diminish unwanted vibration after ejection.

However, in the design shown in FIG. 2, as stated above, the resonance frequency of the pressure chambers is low and ejection at the same frequency as the ejection element 10 in FIG. 1, namely, 150 kHz, is not possible. Furthermore, refilling of ink is not sufficiently rapid.

Moreover, in order to raise the drive voltage so as to increase the volume of the ejected droplet, it is necessary to use a piezoelectric material having correspondingly high performance, and this is not necessarily easy to achieve. Furthermore, if the applied drive voltage is high, then there is a problem in that the lifespan of the piezoelectric actuator is shortened.

### Embodiments of the Present Invention

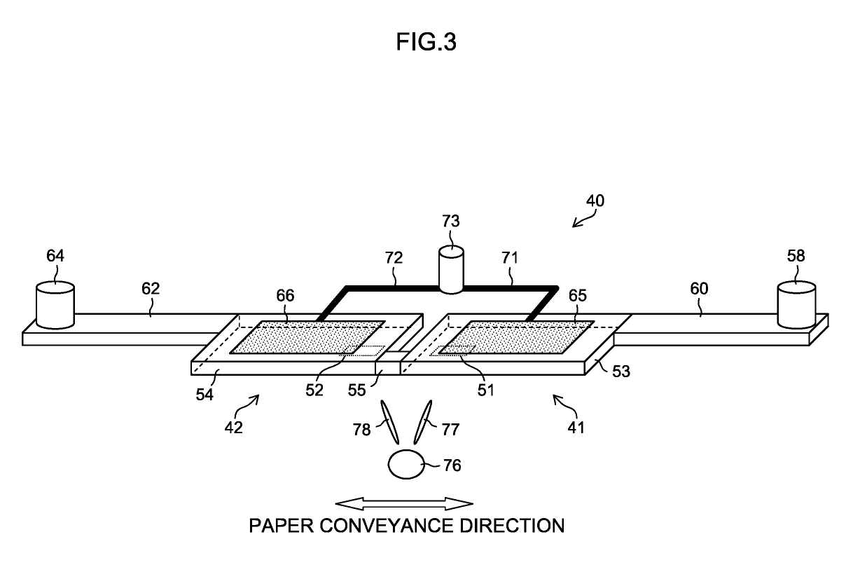

Therefore, in embodiments of the present invention, a composition is adopted in which one pixel is formed by a plurality of ejection elements (in FIG. 3, by two ejection elements), in order to maintain a high resonance point of the pressure chambers as stated above, while also increasing the volume of the ejected droplets.

FIG. 3 is a schematic drawing showing the composition of an inkjet head according to an embodiment of the present invention. In the inkjet head 40 shown in FIG. 3, a plurality of ejection elements 41 and 42 having the same characteristics constitute one set, and one pixel on an image formation medium is recorded by droplets ejected from this set of ejection elements 41 and 42. The combination of the first and second ejection elements 41 and 42 serves as a recording element which carries out recording of a pixel.

The first ejection element 41 includes a first nozzle (corresponding to an “ejection port”) 51, a first pressure chamber 53, a first supply flow channel 60, and a first piezoelectric actuator 65. The second ejection element 42 has the similar structure that is symmetrical to the first ejection element 41, and includes a second nozzle (corresponding to an “ejection port”) 52, a second pressure chamber 54, a second supply flow channel 62, and a second piezoelectric actuator 66.

The second supply flow channel 62 also functions as a circulation flow channel, and then this is also referred to as the “circulation flow channel 62”.

A flow channel structure is formed in which the first pressure chamber 53 having the first nozzle 51 and the second pressure chamber 54 having the second nozzle 52 are connected through a joint flow channel 55. The first supply flow channel 60 is connected to the first pressure chamber 53, and the second supply flow channel (circulation flow channel) 62 is connected to the second pressure chamber 54. In this way, the recording element in the inkjet head 40 according to the present embodiment has the flow channel structure symmetric about the joint flow channel 55.

The ink which has been introduced from the ink inlet port 58 enters into the first pressure chamber 53 through the first supply flow channel 60, and flows into the second pressure chamber 54 from the first pressure chamber 53 through the joint flow channel 55. Furthermore, the ink inside the second pressure chamber 54 flow through the second supply flow channel (circulation flow channel) 62 and exits to the exterior from the ink outlet port 64. During continuous ejection, the ink outlet port 64 and the second supply flow channel 62 function respectively as an ink supply port (inlet port) and a supply flow channel, and the ink is supplied into the second pressure chamber 54 from the ink outlet port 64 by flowing through the second supply flow channel 62.

The first and second piezoelectric actuators 65 and 66 serve as ejection energy generating elements and are arranged respectively in the first and second pressure chambers 53 and 54, which are connected through the joint flow channel 55. Upper electrodes of the first and second piezoelectric actuators 65 and 66 arranged correspondingly to the first and second pressure chambers 53 and 54 are mutually connected through wiring electrodes 71 and 72 and a common signal wire 73 (i.e., the upper electrodes are connected to the same potential), and the upper electrodes are connected to a drive circuit (not shown) through the common signal wire 73.

Thus, the driving operations of the two nozzles 51 and 52 arranged in the first and second pressure chambers 53 and 54 are simultaneously carried out through the common signal wire 73. The first and second nozzles 51 and 52 are disposed in close mutual proximity, and the respective nozzles 51 and 52 are arranged in end positions distanced from the centers of the respective pressure chambers 53 and 54 when observed in plan view, and therefore the droplet ejection directions are obliquely deflected from the vertical direction in FIG. 3. In the case of the composition shown in FIG. 3, since the first nozzle 51 is arranged on the left-hand end of the first pressure chamber 53, droplets ejected from the first nozzle 51 are deflected toward the left-hand side; and since the second nozzle 52 is arranged on the right-hand end of the second pressure chamber 54, droplets ejected from the second nozzle 52 are deflected toward the right-hand side.

A droplet ejected from the first nozzle 51 and a droplet ejected from the second nozzle 52 are deflected in mutually approaching directions, and furthermore, the distance between the first nozzle 51 and the second nozzle 52 is set in such a manner that the two droplets combine with each other immediately after the ejection and then form a dot corresponding to one pixel on the recording medium. Satellite droplets 77 and 78 are formed of the ink that has been ejected respectively from the first and second nozzles 51 and 52 following the ink forming the main droplets which have combined to form a droplet 76. FIG. 3 shows a state where the combined droplet 76 has been formed by two droplets combining with each other during flight, but it is also possible to perform droplet ejection in such a manner that the two droplets make contact with each other virtually simultaneously with arriving at the paper (image formation medium), or in such a manner that the two droplets are at least partially overlapping on the paper. If the two droplets are ejected so as to make contact or be partially overlapping in this way, then the two droplets are immediately combined into one droplet due to the surface tension of ink, and the dot formed approaches a round shape. Although it depends on the magnitude of the surface tension of the ink used, in an example of ink having a surface tension of approximately 35 mN/m, a dot formed by the combined droplets of the ink had a diameter ratio in the two perpendicular directions of approximately 1:1.1 to 1:1.2.

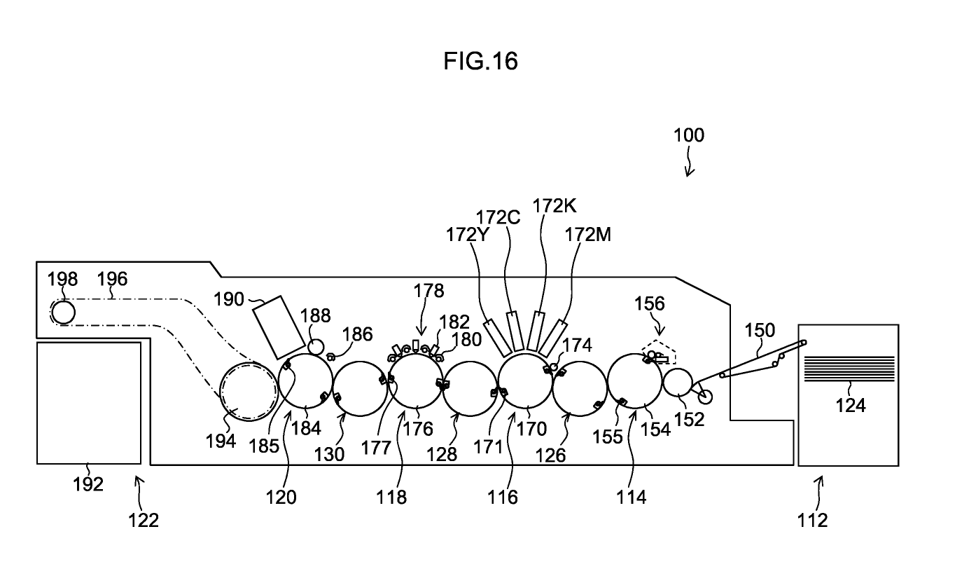

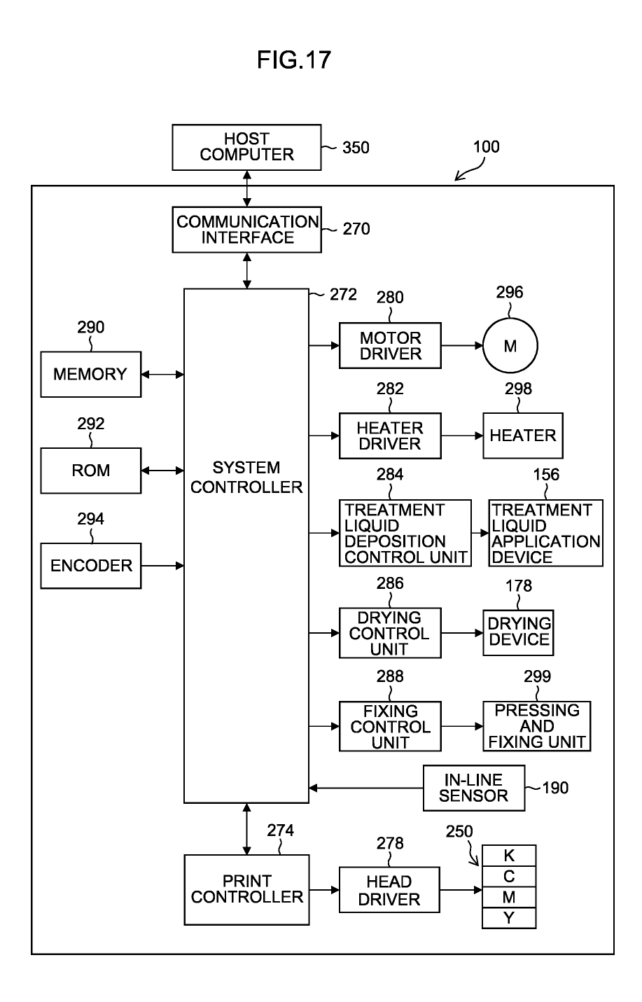

In the inkjet head 40 according to the present embodiment, the alignment direction of the first and second nozzles 51 and 52, which constitute the set that carries out recording of the same pixel, is parallel to the conveyance direction of the paper (which corresponds to the “relative movement direction”). By adopting this arrangement, the deflection directions of the droplets ejected from the first and second nozzles 51 and 52 (the ejection deflection directions of the nozzles) become substantially parallel to the paper conveyance direction, and therefore stripe-shaped non-uniformity due to the flight deflection of the droplets is not liable to appear on the paper. The reasons for this can be described as follows. Firstly, if there is large error in the pitch between adjacent pixels on the paper in the direction perpendicular to the paper conveyance direction, then this is readily visible as non-uniformity. This is very notable in an inkjet system which performs image formation by a one-pass method, as in the embodiment described below with reference to FIGS. 16 and 17. On the other hand, if there is a difference in the ejection speed and/or ejection volume between the first and second ejection elements 41 and 42, due to manufacturing errors, for example, and the two droplets that have combined reach the paper at a position displaced from the ideal position, then the direction of this displacement is substantially parallel to the paper conveyance direction, and hence there is small error in the pitch between adjacent pixels in the direction perpendicular to the paper conveyance direction and stripe-shaped non-uniformities are not liable to appear on the paper.

In the embodiment shown in FIG. 3, the two ejection elements 41 and 42 which form one pixel are arranged, 3 pl droplets are ejected respectively from the two nozzles 51 and 52 of the ejection elements 41 and 42 and the two droplets are made to combine with each other, and a dot corresponding to one pixel is formed by this combined droplet 76. By utilizing the characteristic features of simultaneous ejection by the two nozzles 51 and 52, the first and second pressure chambers 53 and 54 are linked through the joint flow channel 55, and the flow channel structure is thus simplified. The first and second pressure chambers 53 and 54 are connected and arranged in mutual proximity, but since the two nozzles 51 and 52 simultaneously perform ejection, it is possible to ignore the problem of cross-talk (fluid interference). This is because no cross-talk occurs due to the pressure wave or ink flow generated in one of the pressure chambers being transmitted to the other, since the first and second piezoelectric actuators 65 and 66 of the first and second pressure chambers 53 and 54 are simultaneously driven by the same amount, and the forces seeking to deform the partition between the first and second pressure chambers 53 and 54 which are generated by the driving of the first and second piezoelectric actuators 65 and 66 do not affect each other and hence do not produce cross-talk, because the ejection elements 41 and 42 are in a geometrically symmetrical composition as described below.

The present embodiment employs the flow channel system (ink circulation system) which circulates the ink inside the pressure chambers 53 and 54, but since the flow channel structure is symmetric about the joint flow channel 55 horizontally in FIG. 3, then in a case where the first and second piezoelectric actuators 65 and 66 are being simultaneously driven by the same amount, each of the pressure chambers 53 and 54 is equivalent to a pressure chamber that has only the ink supply flow channel and no ink circulation flow channel, in terms of fluid dynamics. The reasons for this are as follows. Firstly, the pressure waves and ink flows generated when the first and second piezoelectric actuators 65 and 66 are simultaneously driven by the same amount arrive simultaneously from the respective pressure chambers 53 and 54 and collide with each other in the center of the joint flow channel 55. The ink seeks to flow into the joint flow channel 55 by similar amounts from both the right-hand side and the left-hand side, and therefore the velocity of the ink becomes zero at the center of the joint flow channel 55. Moreover, the pressure waves are symmetrically transmitted between the pressure chambers 53 and 54, taking the cross-sectional plane at the center of the joint flow channel 55 as a mirror symmetry plane. This state is the same with a case where a wall having infinite rigidity is arranged at the center of the joint flow channel 55. Consequently, the pressure chambers 53 and 54 are equivalent to the pressure chambers which only have the ink supply flow channels and do not have any ink circulation flow channels, in other words, in which the center of the joint flow channel 55 is a dead end.

Hence, in the composition of the present embodiment, when performing ejection, since the two pressure chambers 53 and 54 are simultaneously applied with pressure, then the joint flow channel 55 and the partition wall (dividing wall) between the pressure chambers 53 and 54 receive pressure from the respective piezoelectric actuators 65 and 66 simultaneously from the right-hand side and the left-hand side. By receiving pressure of equal magnitude simultaneously from the right-hand side and the left-hand side, the partition wall and the portion of the joint flow channel 55 can be regarded as having infinite rigidity.

Consequently, in order to achieve resonance and ink refilling performance similar to the inkjet head design shown in FIG. 1, each of the first supply flow channel 60 and the second supply flow channel (circulation flow channel) 62 in FIG. 3 is designed to have the length and the cross-sectional surface area whereby the flow channel resistance and the flow channel inertance in each of the first supply flow channel 60 and the second supply flow channel (circulation flow channel) 62 are close respectively to the combined flow channel resistance and the combined flow channel inertance of the supply flow channel 20 and the circulation flow channel 22 in the inkjet head design in FIG. 1. Here, the resistance R and the inertance L of a flow channel are expressed as follows:

R∝1/S²;and (1)

L∝1/S, (2)

where 1 is the length of the flow channel, and S is the cross-sectional surface area of the flow channel.

When the dimensions of the supply flow channel 20 and the dimensions of the circulation flow channel 22 are equal to each other as in FIG. 1, the combined supply channel resistance of the supply flow channel 20 and the circulation flow channel 22 is a half of the supply channel resistance in each of the supply flow channel 20 and the circulation flow channel 22, and the combined supply channel inertance of the supply flow channel 20 and the circulation flow channel 22 is two times the supply channel inertance in each of the supply flow channel 20 and the circulation flow channel 22. Therefore, by solving the above-described simultaneous equations (1) and (2), it is found that the supply channel resistance and the supply channel inertance of each of the first supply flow channel 60 and the second supply flow channel (circulation flow channel) 62 in FIG. 3 become equal respectively to the combined supply channel resistance and the combined supply channel inertance of the supply flow channel 20 and the circulation flow channel 22, when the cross-sectional area of each of the first supply flow channel 60 and the second supply flow channel (circulation flow channel) 62 is four times the cross-sectional area of each of the supply flow channel 20 and the circulation flow channel 22, and the length of each of the first supply flow channel 60 and the second supply flow channel (circulation flow channel) 62 is eight times the length of each of the supply flow channel 20 and the circulation flow channel 22.

### <Description of Ink Circulation Operation>

The ink circulation operation in the flow channel design shown in FIG. 3 is as described below. While no ejection is being performed, the ink slowly flows into one of the pressure chambers (the first pressure chamber 53 shown on the right-hand side in FIG. 3) from the first supply flow channel 60, the ink then flows through the joint flow channel 55 into the other of the pressure chambers (the second pressure chamber 54 shown on the left-hand side in FIG. 3), and then exits through the second supply flow channel (circulation flow channel) 62. The nominal value of the ink flow volume varies with the composition of the ink, and in the case of the aqueous ink used in the present embodiment, for instance, the effects of increased viscosity of the ink in the vicinity of the nozzles is suppressed at a flow of several hundred to several thousand picoliters per second, per nozzle.

While ejection is being performed, the ink is refilled into the pressure chambers 53 and 54 after ink ejection through the supply flow channels 60 and 62 which are respectively connected to the pressure chambers 53 and 54. In other words, the second supply flow channel 62 which is connected to the second pressure chamber 54 functions as the ink supply flow channel during the ejection operation. When the ejection operation is halted, the ink is circulated again along the following path: the first supply flow channel 60→the first pressure chamber 53→the joint flow channel 55→the second pressure chamber 54→the second supply flow channel (circulation flow channel) 62.

In each of the pressure chambers 53 and 54, the portion to which the supply flow channel 60 or 62 is connected and the portion to which the joint flow channel 55 is connected are arranged in substantially diagonally opposing positions of each pressure chamber when observed in plan view, thereby forming the flow channel structure in which stagnation is not liable to occur in each pressure chamber. Since each of the pressure chambers 53 and 54 has a square shape in plan view, then the connections of the flow channels are arranged in diagonally opposing positions in the present embodiment, but if each pressure chamber is circular, elliptical or polygonal in shape, then a desirable mode is one where the connections of the supply flow channel and the joint flow channel are arranged at positions in the chamber walls which are furthest distanced from each other.

### <Effect in Raising Refilling Efficiency>

In the composition of the embodiment shown in FIG. 3, one small-diameter nozzle for 3 pl droplets described in FIG. 1 is arranged for each of the pressure chambers 53 and 54, in other words, a total of two small-diameter nozzles 51 and 52 in FIG. 3 are arranged, and compared to the composition where one large-diameter nozzle for 6 pl droplets is arranged as described in FIG. 2, the size of the meniscus is reduced and therefore the surface tension of the meniscus is larger, the refilling resonance is shorter and is improved, and the ink refilling properties are raised.

The head shown in FIG. 3 has the ink circulating flow channel structure, but has the characteristic feature in that it is possible to ignore the movement of liquid between the pressure chambers 53 and 54 through the joint flow channel 55 during the ejection operation, and the head can be regarded as having the design of “pressure chamber provided with only ink supply flow channel” as described above. Consequently, the design of the resonance system for ejection and the design of the refill resonance system are made comparatively simple and performance can be improved, which is beneficial. In other words, it is possible to reduce refilling resistance while maintaining a high resonance frequency, and even when continuous ejection is carried out at a high frequency, the ink can be reliably refilled.

<Description with Reference to a Cross-Sectional Diagram>

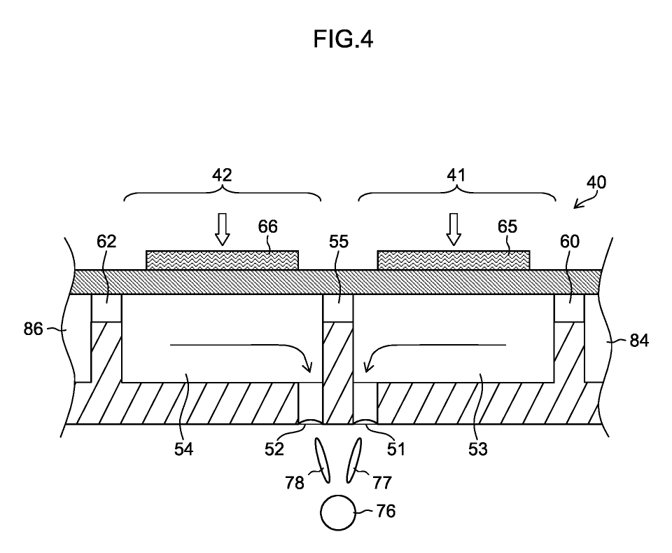

FIG. 4 is a cross-sectional diagram of the inkjet head 40 having the pair of ejection elements 41 and 42 shown in FIG. 3. The first pressure chamber 53 is connected to a common liquid chamber on the supply side (supply common flow channel) 84 through the first supply flow channel 60. Similarly, the second pressure chamber 54 is connected to a common liquid chamber on the circulation side (circulation common flow channel) 86 through the second supply flow channel 62. This flow channel structure can be manufactured by etching a silicon (Si) substrate to form grooves, apertures, and the like, which are to become a flow channel part.

According to the inkjet head of the present embodiment, during ejection, the first and second piezoelectric actuators 65 and 66 are simultaneously driven, and droplets are ejected from the first and second nozzles 51 and 52. These two droplets combine together to form a dot of one pixel on the paper. After ejection, the ink is refilled into the first pressure chamber 53 through the first supply flow channel 60, and the ink is also refilled into the second pressure chamber 54 through the second supply flow channel 62.

In FIGS. 3 and 4, the composition is described in which the two ejection elements 41 and 42 constitute the set, but in implementing the present invention, the number of ejection elements constituting a set which carry out the formation of the same single pixel is not limited to two. It is also possible to design a composition with three or more ejection elements, and to arrange a suitable number of pressure chambers of no less than two to constitute a set. The volume of the ejected liquid which performs recording of one pixel becomes larger in proportion with the number of pressure chambers which constitute the set.

### <Arrangement of Pressure Chambers Constituting a Set>

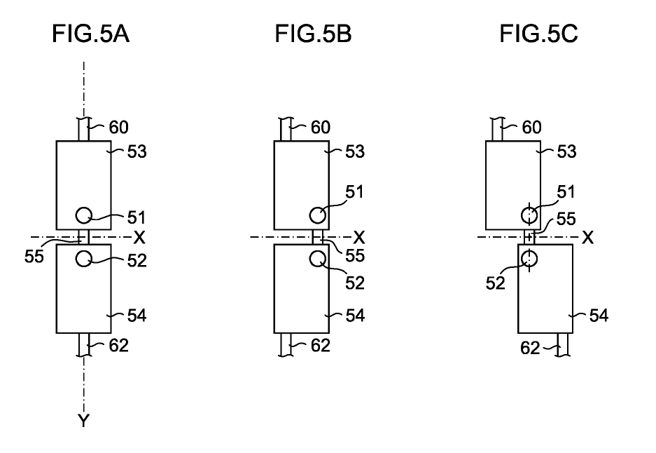

FIGS. 5A to 5C are plan diagrams showing schematic views of examples of the arrangement of two ejection elements which constitute a set. In FIGS. 5A to 5C, elements which are the same as or similar to the composition in FIG. 3 are denoted with the same reference numerals and further explanation thereof is omitted here.

The arrangement of the ejection elements shown in FIG. 5A is mirror symmetrical in the vertical direction with respect to the horizontal center line X and is also mirror symmetrical in the horizontal direction with respect to the vertical center line Y. The arrangement of the ejection elements shown in FIG. 5B is mirror symmetrical with respect to the horizontal center line X. The arrangement of the ejection elements shown in FIG. 5C is rotationally symmetrical about the joint flow channel 55.

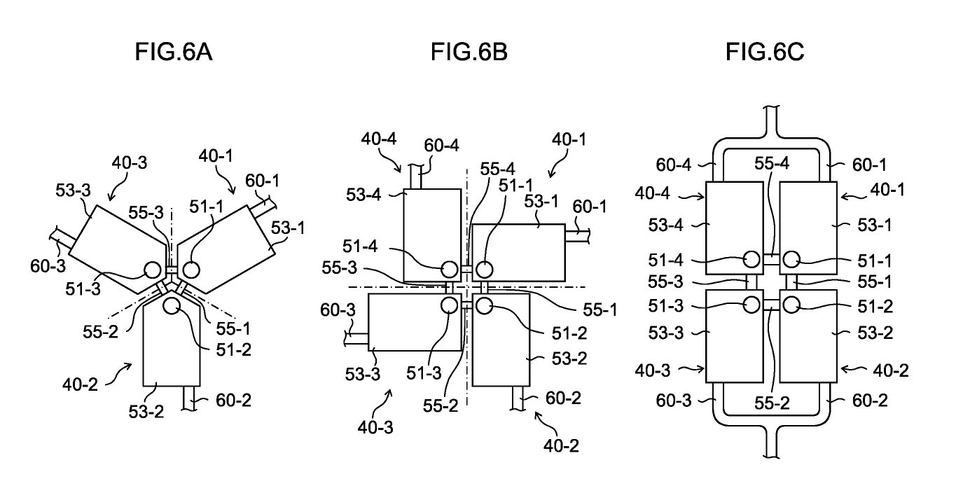

FIGS. 6A to 6C show examples of a composition in which three or more ejection elements constitute a set. In FIGS. 6A to 6C, the j-th (j=1, 2, 3, 4) ejection element is denoted with the reference numeral 40-j, the j-th nozzle is denoted with 51-j, the j-th pressure chamber is denoted with 53-j, the j-th joint flow channel is denoted with 55-j, and the j-th supply flow channel is denoted with 60-j.

FIG. 6A shows a case where three ejection elements 40-j (j=1, 2, 3) are in a rotationally symmetrical arrangement. One or two of the supply flow channels 60-j arranged in the pressure chambers 53-j also serve as the circulation flow channel.

FIG. 6B shows a case where four ejection elements 40-j (j=1, 2, 3, 4) are in a rotationally symmetrical arrangement. FIG. 6C shows a case where four ejection elements 40-j are in an arrangement which is mirror symmetrical in the vertical direction with respect to the horizontal center line X and is also mirror symmetrical in the horizontal direction with respect to the vertical center line Y. In FIGS. 6B and 6C, the four pressure chambers 53-j are linked in a ring shape through the joint flow channels 55-j, but it is also possible to adopt a composition in which the joint flow channels 55-2 and 55-4 are omitted, for example, and the pressure chambers 53-j are connected two each in series.

### <Shape of Nozzle Opening>

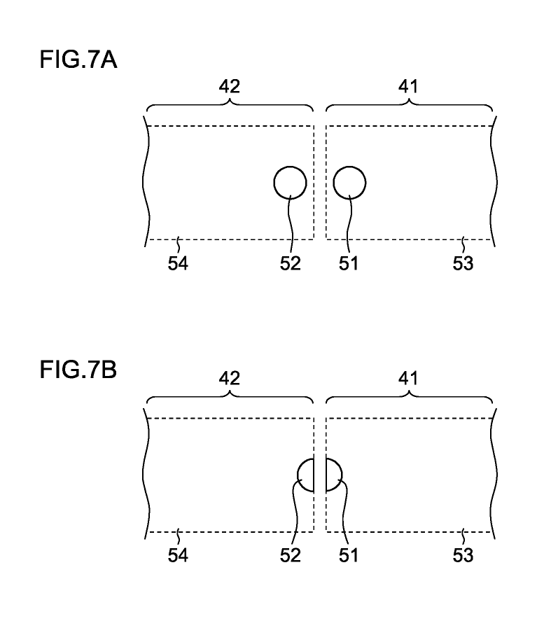

FIGS. 7A and 7B are diagrams showing modification examples of ejection ports of ejection elements (41 and 42 in FIG. 3) constituting a set. Each of the nozzles 51 and 52 can have a circular shape as shown in FIG. 7A. Alternatively, each of the nozzles 51 and 52 can have a semicircular shape so that the two nozzles 51 and 52 constituting the pair form a substantially circular shape as shown in FIG. 7B.

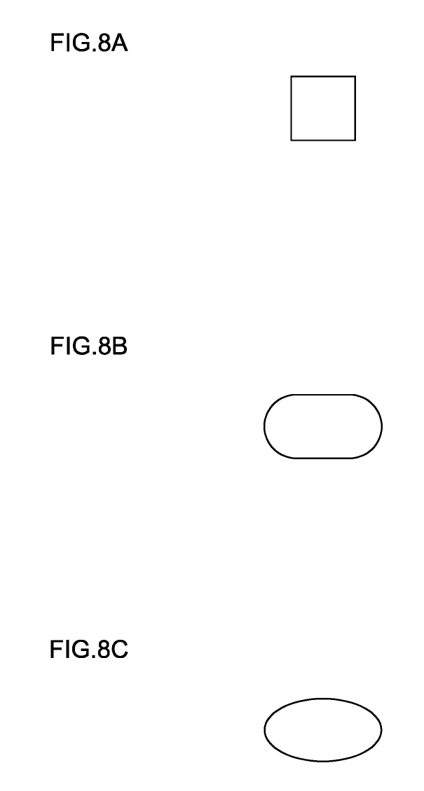

The nozzle shape is not limited to the circular shape. For example, it may also be a square shape as shown in FIG. 8A, an elongated circular shape as shown in FIG. 8B, an elliptical shape as shown in FIG. 8C, or the like. Furthermore, it is also possible to adopt a mode employing a split nozzle shape in which each of the shapes shown in FIGS. 8A to 8C is divided into two equal parts in the horizontal direction by a center line following the vertical direction in the drawing, one part forming the nozzle shape of the first nozzle 51 and the other part forming the nozzle shape of the second nozzle 52.

### <Single Nozzle>

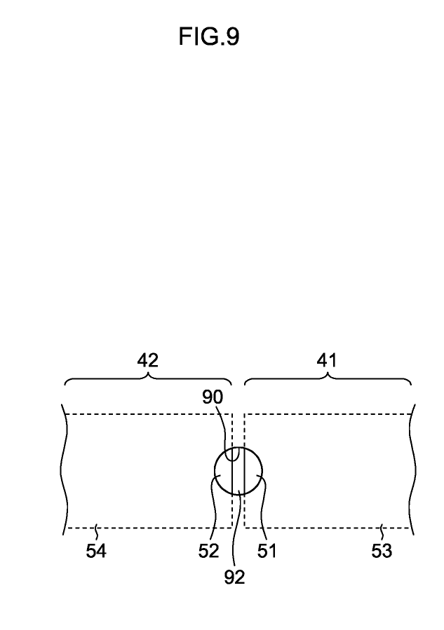

Moreover, as shown in FIG. 9, it is also possible to adopt a mode in which a single nozzle section 90 is formed which spans between an ejection port (corresponding to the first nozzle 51) of the first ejection element 41 and an ejection port (corresponding to the second nozzle 52) of the second ejection element 42. A partition 92 is disposed inside the nozzle section 90, and the first nozzle 51 and the second nozzle 52 are formed on either side of the partition 92.

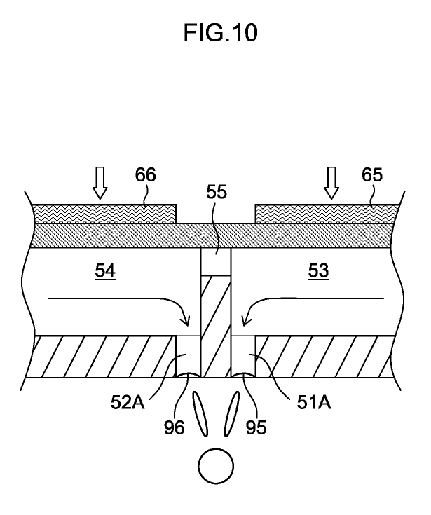

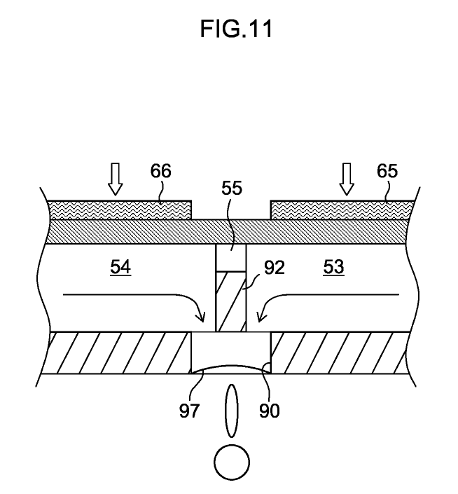

In the mode shown in FIG. 10, individual ejection ports (corresponding to the first and second nozzles 51 and 52) are respectively formed for the first and second pressure chambers 53 and 54, and meniscuses 95 and 96 are formed in the respective ejection ports. Alternatively, in a mode shown in FIG. 11, a single meniscus 97 is formed in a single nozzle section 90.

In the case of the composition shown in FIG. 11, the nozzle section 90 having a long and narrow opening connecting to the two ejection ports (corresponding to the first and second nozzles 51 and 52) is arranged directly below the partition 92 of the two pressure chambers 53 and 54. By forming the single nozzle section 90 in this way, liquids ejected from the respective ejection ports combine together in the nozzle section 90, and therefore the liquids are ejected from the nozzle section 90 in the form of a combined droplet.

It is desirable that the nozzle section 90 has a linear flow channel parallel to the ejection direction, in order that the liquids combine together to be propelled in a straight direction.

Furthermore, also in the composition shown in FIG. 10, in order to raise the ejection direction accuracy of the ejection elements 41 and 42, a desirable mode is one where linear flow channels (denoted with reference numerals 51A and 52A in FIG. 10) which are parallel to the ejection direction are arranged between the pressure chambers 53 and 54 and the droplet outlets (the ends of the ejection ports).

### <Actions and Beneficial Effects of the Embodiments of the Present Invention>

According to the embodiments of the present invention, it is possible to provide the inkjet head which drives the ejection elements that form the same pixel by means of a single common electric wire, and which ejects a large droplet volume at a high drive frequency.

If the ejection elements are simply increased in number, then the structure of the inkjet head becomes complex, the electric circuitry required to drive the head becomes large in size, manufacture becomes difficult, costs become high, and reliability declines.

In this respect, according to the embodiments of the present invention, the composition is adopted in which each set of the ejection elements 41 and 42 is driven by the same drive signal, and the drive signal can be conveyed through the single signal wire 73 to the vicinity of the actuators of the ejection elements 41 and 42 which constitute the same set. Therefore, the composition and wiring of the control system can be simplified.

According to the embodiments of the present invention, the ink circulation flow channel is provided to circulate the liquid in the vicinity of the nozzles at all times, in order to achieve stable ejection over a long period of time. If ink circulation flow channels are provided individually for the ejection elements, then the circulation flow channels and supply flow channels also increase in number as the ejection elements increase, and the structure of the inkjet head becomes complex. In this respect, in the embodiments of the present invention, by circulating the liquid between the ejection elements constituting each set through the joint flow channel 55, the required number of circulation flow channels and supply flow channels is only half the number of ejection elements.

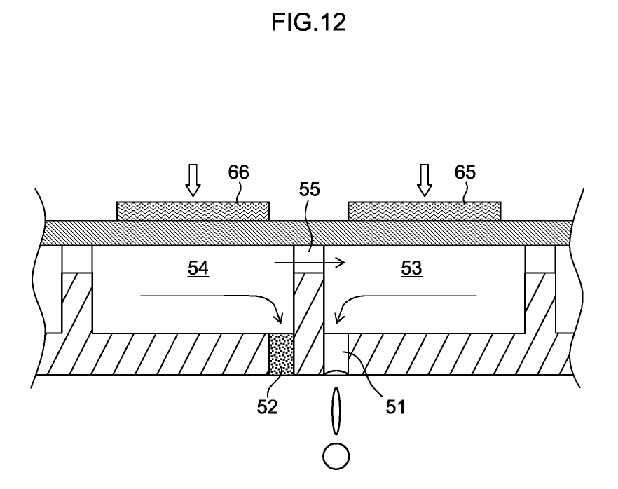

Moreover, in the embodiments of the present invention, even if one nozzle of the set of ejection elements becomes blocked and can no longer eject ink, it is still possible to eject ink from the remaining nozzle in the set as shown in FIG. 12, in which a state where the nozzle 52 has been blocked is shown as an example, and therefore a complete ejection failure (dot recording incapability) is not liable to occur. Furthermore, as shown in FIG. 12, the ink that has been applied with pressure by the actuator 66 corresponding to the blocked nozzle 52 flows through the joint flow channel 55 and has an effect of increasing the ejection volume of the other nozzle (the nozzle that is not blocked) 51, and therefore, although the ejection volume is smaller than the ejection volume when both of the nozzles are functioning normally, it is possible to eject ink of a volume close to this normal ejection volume.

If one of the nozzles constituting a set does not perform ejection, then the direction of flight of the droplet ejected from the other nozzle is slightly deflected toward the side of the nozzle that is not ejecting; however, in the embodiments of the present invention, this direction of flight deflection is parallel to the relative conveyance direction of the paper (print medium) and the inkjet head, and therefore stripe-shaped non-uniformities are not readily visible on the paper.

The embodiments of the present invention are described above with respect to cases where the droplets ejected from the nozzles constituting a set combine together before reaching the print medium, and form one dot; however, the present invention is not limited to the mode where the droplets combine together during flight, and it is also possible for dots formed by the respective droplets to be overlapped at least partially on the print medium.

If the ejected droplets combine together before landing, then the combined droplet travels in the direction of the combined momentums of the ejected droplets, and therefore the ejection direction accuracy is improved in average terms.

If the dots are mutually overlapping on the print medium, then there are respective errors in the flight direction accuracy of the ejected droplets; however, by adopting the composition according to the embodiments of the present invention, the droplets are always ejected simultaneously from the nozzles constituting a set, and therefore the errors are averaged in the one pixel recorded by the dots formed by the droplets, and the positional accuracy of the pixel is improved in average terms. Moreover, if a line is drawn along a direction parallel to the direction of relative movement of the print medium by an inkjet type of print head, then gaps between the pixels may occur and stripe-shaped non-uniformities due to variation in the size of the gaps are liable to become problematic; however, in the composition according to the embodiments of the present invention, one line is formed by droplets ejected from a plurality of nozzles, and therefore the gaps are also averaged and the extent of stripe-shaped non-uniformity is improved.

Furthermore, in the composition where the piezoelectric bodies are used as the actuators for driving the respective pressure chambers, the piezoelectric bodies of the actuators which drive the individual pressure chambers are separated into individual bodies. Therefore, it is possible to reduce cross-talk between the pressure chambers.

In the piezoelectric bodies described above, a composition may be adopted in which the piezoelectric bodies of respective ejection elements of the same set are not separated from each other. By adopting this composition, the surface area that is exposed at the end face portions of the piezoelectric bodies is reduced and the probability of short-circuiting due to deterioration over time can be lowered, which is advantageous in terms of life span.

### <Composition for Suppressing Effects of Manufacturing Variations>

In the composition according to the embodiments of the present invention which has been described in detail with reference to FIG. 3 and so on, in order to make the ejection direction of the droplets follow the desired direction accurately, it is desirable that the respective ejection elements should have matching characteristics and accuracy. The characteristics referred to here include: the resonance frequency of the whole ejection element, the dimensions of the pressure chamber, the dimensions of the nozzle, the shape of the nozzle, the displaced volume (excluding volume) of the actuator, and the dimensions of the ink supply channel. If there are errors in these characteristics, then deviations occur in the speed, volume and ejection timing of the droplets ejected from the nozzles of the respective ejection elements, and the volume and also the ejection direction of the droplets fluctuate.

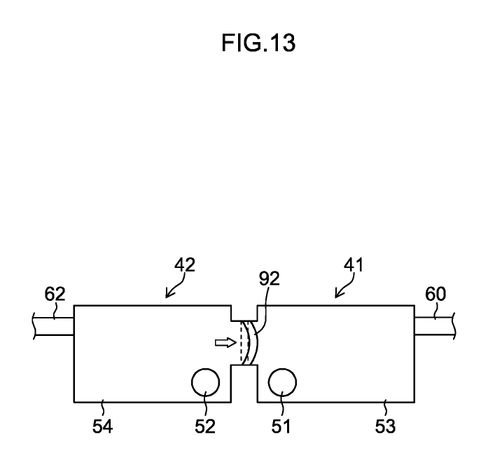

Therefore, in an embodiment described below with reference to FIG. 13, in order to reduce the effects of errors in the displaced volumes of the actuators, in particular, at least a portion of the partition 92 that separates the pressure chambers 53 and 54 of the ejection elements 41 and 42 is composed flexibly so as to be capable of deforming due to the pressure applied by the actuators during ejection. In FIG. 13, elements which are the same as or similar to the composition shown in FIG. 3, or the like, are denoted with the same reference numerals.

By arranging the flexibly deformable partition (movable wall) 92 between the two pressure chambers 53 and 54 as shown in FIG. 13, if a difference occurs in the excluded volume (pressure) between the two pressure chambers 53 and 54, the partition 92 deforms from the larger toward the smaller excluded volume, thereby absorbing the difference in the excluded volume. In this composition, the displacement of the partition 92 stops when the pressures applied on the right-hand surface and the left-hand surface of the partition 92 in FIG. 13 are mutually balanced. In the general design of the inkjet head in the related art (see FIGS. 1 and 2, for example), if the walls of the pressure chamber are flexible, then there is a problem due to loss of the pressure generated by the actuator; however, in the composition according to the embodiments of the present invention, provided that the respective ejection elements have the same characteristics, the pressures applied on the both surfaces of the partition are the same, the partition is not displaced, and hence there is no loss of the pressures generated by the actuators. If the characteristics of the respective ejection elements vary due to manufacturing variations, or the like, then the partition 92 is displaced in a direction which absorbs the effects of the variations and the droplet ejection statuses of the two pressure chambers 53 and 54 can be matched with each other, thereby making it possible to raise the ejection direction accuracy.

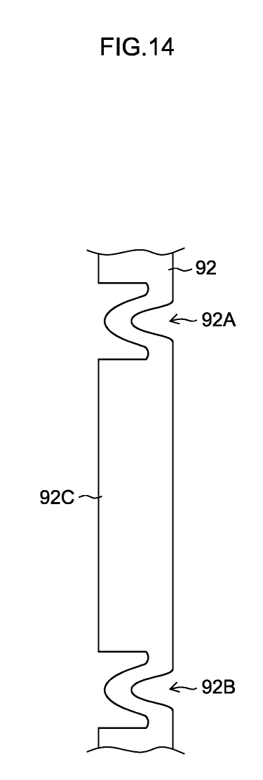

FIG. 14 is an enlarged diagram showing the partition 92 in the embodiment of the present invention. This partition 92 has pleat-shaped (bellows-shaped) bent sections 92A and 92B in order to enable flexible deformation.

### <Method of Manufacturing Movable Wall>

The inkjet head having the movable wall (flexible partition) 92 shown in FIGS. 13 and 14 can be manufactured by etching a silicon (Si) substrate, for example. In this case, in order to achieve a structure which allows the partition 92 to move, a wall portion 92C and the bellows-shaped bent sections 92A and 92B are formed with small gaps respectively to the floor part and the ceiling part of the pressure chamber, which are situated in the upper and lower sides of the partition 92. These gaps can be formed readily by etching.

The floor and ceiling of the pressure chambers are respectively constituted of a nozzle plate and a diaphragm, and these are assembled with the side walls of the pressure chambers by thermal diffusion bonding. Since the portions of the partition 92 defining the above-described gaps are not bonded, then the movable wall can be formed.

### <Drive Waveform for Image Recording>

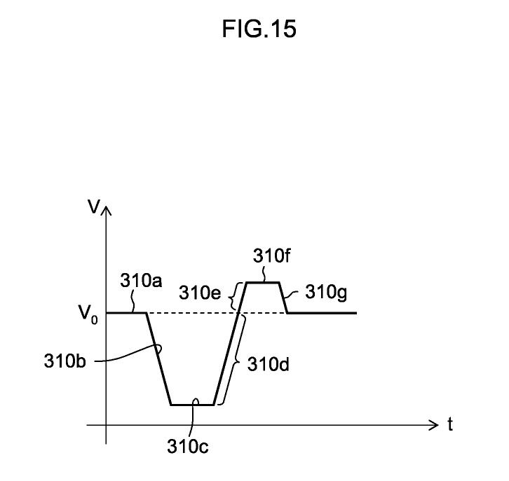

FIG. 15 is a waveform diagram showing a voltage waveform of a drive signal (drive waveform) which is applied to the actuator during image recording according to an embodiment of the present invention. Here, in order to simplify the description, a so-called pull-push type of drive waveform is described as an example. However, in implementing the present invention, there are no particular restrictions on the mode of the drive waveform, and drive waveforms of various other types, such as a pull-push-pull waveform can be used.

The drive waveform shown in FIG. 15 includes: a first signal element 310a, which outputs a reference potential V₀ that maintains the volume of the pressure chamber in a steady state; a second signal element (pull waveform portion) 310b, which drives the actuator in a direction to expand the pressure chamber from the steady state; a third signal element 310c, which maintains the pressure chamber in an expanded state; a fourth signal element (push waveform portion) 310d, which drives the actuator in a direction to push and compress the pressure chamber; a fifth signal element 310e, which drives the actuator in a direction that pushes out liquid of a satellite portion; a sixth signal element 310f, which maintains the pressure chamber in the compressed state produced by the fifth signal element 310e; and a seventh signal element 310g, which returns the pressure chamber to the steady state. The waveform portions from the fifth signal element 310e to the seventh signal element 310g, which follow on from the fourth signal element 310d, are the waveform elements for driving the actuator in the direction to push out liquid when the liquid of a satellite portion passes the vicinity of the nozzle after a main droplet has been pushed out. By this means, the ejection speed of the satellite is accelerated, and the satellite droplet is made to collide with the main droplet in flight, thereby forming a combined droplet.

### Composition of Inkjet Printing Apparatus

An inkjet image forming apparatus using the inkjet head according to the embodiment of the present invention described above is explained below.

FIG. 16 is a general schematic drawing showing the composition of an inkjet printing apparatus according to an embodiment of the present invention. The inkjet printing apparatus 100 in the present embodiment includes a paper supply unit 112, a treatment liquid deposition unit (pre-coating unit) 114, an image formation unit 116, a drying unit 118, a fixing unit 120, and a paper output unit 122. The inkjet printing apparatus 100 is a single-pass inkjet printing apparatus, which forms a desired color image by ejecting and depositing droplets of inks of a plurality of colors from inkjet heads 172M, 172K, 172C and 172Y onto a recording medium 124 (corresponding to an “image formation medium”, also called “paper” below for the sake of convenience) held on a pressure drum (image formation drum) 170 of the image formation unit 116. The inkjet printing apparatus 100 is an image forming apparatus of an on-demand type employing a two-liquid reaction (aggregation) method in which an image is formed on the recording medium 124 by depositing a treatment liquid (here, an aggregating treatment liquid) on the recording medium 124 before depositing droplets of ink, and causing the treatment liquid and ink liquid to react together.

### <Paper Supply Unit>

Cut sheets of recording medium 124 are stacked in the paper supply unit 112 and the recording medium 124 is supplied, one sheet at a time, to the treatment liquid deposition unit 114, from a paper supply tray 150 of the paper supply unit 112. In the present embodiment, cut sheet paper (cut paper) is used as the recording medium 124, but it is also possible to adopt a composition in which paper is supplied from a continuous roll (rolled paper) and is cut to the required size.

### <Treatment Liquid Deposition Unit>

The treatment liquid deposition unit 114 is a mechanism which deposits the treatment liquid onto a recording surface of the recording medium 124. The treatment liquid includes a coloring material aggregating agent, which aggregates the coloring material (in the present embodiment, the pigment) in the ink deposited by the image formation unit 116, and the separation of the ink into the coloring material and the solvent is promoted due to the treatment liquid and the ink making contact with each other.

The treatment liquid deposition unit 114 includes a paper supply drum 152, a treatment liquid drum (also referred to as “pre-coating drum”) 154 and a treatment liquid application device 156. The treatment liquid drum 154 is a drum which holds the recording medium 124 and conveys the medium so as to rotate. The treatment liquid drum 154 includes a hook-shaped gripping device (gripper) 155 arranged on the outer circumferential surface thereof, and is devised in such a manner that the leading end of the recording medium 124 can be held by gripping the recording medium 124 between the hook of the holding device 155 and the circumferential surface of the treatment liquid drum 154. The treatment liquid drum 154 can have suction holes, which are arranged in the outer circumferential surface thereof and connected to an air sucking device which performs suction through the suction holes. By this means, it is possible to hold the recording medium 124 tightly against the circumferential surface of the treatment liquid drum 154.

The treatment liquid application device 156 is arranged opposing the circumferential surface of the treatment liquid drum 154, to the outside of the drum. The treatment liquid application device 156 includes a treatment liquid vessel in which treatment liquid is stored, an anilox roller (metering roller) which is partially immersed in the treatment liquid in the treatment liquid vessel, and a rubber roller which transfers a dosed amount of the treatment liquid to the recording medium 124, by being pressed against the anilox roller and the recording medium 124 on the treatment liquid drum 154. According to this treatment liquid application device 156, it is possible to apply the treatment liquid to the recording medium 124 while dosing the amount of the treatment liquid.

In the present embodiment, a composition is described which uses the roller-based application method, but the application method is not limited to this, and it is also possible to employ various other methods, such as a spray method, an inkjet method, or the like.

The recording medium 124 onto which the treatment liquid has been deposited by the treatment liquid deposition unit 114 is transferred from the treatment liquid drum 154 to the image formation drum 170 of the image formation unit 116 through an intermediate conveyance unit 126.

### <Image Formation Unit>

The image formation unit 116 includes the image formation drum 170 (also referred to as “jetting drum”), a paper pressing roller 174, and the inkjet heads 172M, 172K, 172C and 172Y. Similarly to the treatment liquid drum 154, the image formation drum 170 includes a hook-shaped holding device (gripper) 171 on the outer circumferential surface of the drum. The recording medium 124 held on the image formation drum 170 is conveyed with the recording surface thereof facing to the outer side, and ink is deposited onto this recording surface from the inkjet heads 172M, 172K, 172C and 172Y.

The inkjet heads 172M, 172K, 172C and 172Y are each full-line type inkjet recording heads having a length corresponding to the maximum width of the image forming region on the recording medium 124, and rows of nozzles (two-dimensionally arranged nozzles) for ejecting ink arranged throughout the whole width of the image forming region are formed in the ink ejection surface of each head. The inkjet heads 172M, 172K, 172Y and 172Y are disposed so as to extend in a direction perpendicular to the conveyance direction of the recording medium 124 (the direction of rotation of the image formation drum 170).

A cassette of the corresponding color ink is installed in each of the inkjet heads 172M, 172K, 172C and 172Y. Droplets of the respective inks are ejected and deposited from the inkjet heads 172M, 172K, 172C and 172Y to the recording surface of the recording medium 124 which is held on the outer circumferential surface of the image formation drum 170.

By this means, the ink makes contact with the treatment liquid that has previously been deposited on the recording surface, and the coloring material (pigment) dispersed in the ink is aggregated to form a coloring material aggregate. The present embodiment uses a reaction between ink and treatment liquid, in which the treatment liquid contains an acid, and when the ink makes contact with the treatment liquid, the pH of the ink is lowered to break down the dispersion of pigment in the ink, and the pigment is thereby caused to aggregate, so as to avoid bleeding of the coloring material, intermixing between inks of different colors, and interference between deposited droplets due to combination of the ink droplets upon landing. Thus, flowing of coloring material, and the like, on the recording medium 124 is prevented and an image is formed on the recording surface of the recording medium 124.

The droplet ejection timings of the inkjet heads 172M, 172K, 172C and 172Y are determined in accordance with an encoder 294 (shown in FIG. 17) which is arranged on the image formation drum 170 to measure the rotational speed of the image formation drum 170. An ejection trigger signal (pixel trigger) is issued according to the measurement signals obtained from the encoder. By this means, it is possible to specify the landing positions of the ejected droplets with high accuracy. Moreover, speed variations caused by inaccuracies in the image formation drum 170, or the like, can be ascertained in advance, and the droplet ejection timings determined with the encoder can be corrected, thereby reducing droplet deposition non-uniformities, irrespectively of inaccuracies in the image formation drum 170, the accuracy of the rotational axle, and the speed of the outer circumferential surface of the image formation drum 170.

Furthermore, maintenance operations such as cleaning the nozzle surfaces of the inkjet heads 172M, 172K, 172C and 172Y, ejecting ink of increased viscosity, and the like, can be carried out with the head unit withdrawn from the image formation drum 170.

Although the configuration with the CMYK standard four colors is described in the present embodiment, combinations of the ink colors and the number of colors are not limited to those. As required, light inks, dark inks and/or special color inks can be added. For example, a configuration in which inkjet heads for ejecting light-colored inks such as light cyan and light magenta are added is possible. Moreover, there are no particular restrictions of the sequence in which the heads of respective colors are arranged.

The recording medium 124 onto which an image has been formed in the image formation unit 116 is transferred from the image formation drum 170 to a drying drum 176 of the drying unit 118 through an intermediate conveyance unit 128.

### <Drying Unit>

The drying unit 118 is a mechanism which dries the water content contained in the solvent that has been separated by the action of aggregating the coloring material, and as shown in FIG. 16, includes the drying drum 176 and a solvent drying device 178. Similarly to the treatment liquid drum 154, the drying drum 176 has a hook-shaped holding device (gripper) 177 arranged on the outer circumferential surface of the drum, in such a manner that the leading end of the recording medium 124 can be held by the holding device 177.

The solvent drying device 178 is disposed in a position opposing the outer circumferential surface of the drying drum 176, and is constituted of halogen heaters 180 and hot air spraying nozzles 182 disposed respectively between the halogen heaters 180. It is possible to achieve various drying conditions, by suitably adjusting the temperature and air flow volume of the hot air flow which is blown from the hot air flow spraying nozzles 182 toward the recording medium 124, and the temperatures of the halogen heaters 180.

By holding the recording medium 124 in such a manner that the recording surface thereof is facing outward on the outer circumferential surface of the drying drum 176 (in other words, in a state where the recording surface of the recording medium 124 is curved in a convex shape), and drying while conveying the recording medium in rotation, it is possible to prevent the occurrence of wrinkles or floating up of the recording medium 124, and therefore drying non-uniformities caused by these phenomena can be prevented reliably.

The recording medium 124 on which the drying process has been carried out in the drying unit 118 is transferred from the drying drum 176 to a fixing drum 184 of the fixing unit 120 through an intermediate conveyance unit 130.

### <Fixing Unit>

The fixing unit 120 includes the fixing drum 184, a halogen heater 186, a fixing roller 188 and an in-line sensor 190. Similarly to the treatment liquid drum 154, the fixing drum 184 has a hook-shaped holding device (gripper) 185 arranged on the outer circumferential surface of the drum, in such a manner that the leading end of the recording medium 124 can be held by the holding device 185.

By means of the rotation of the fixing drum 184, the recording medium 124 is conveyed with the recording surface facing to the outer side, and preliminary heating by the halogen heater 186, a fixing process by the fixing roller 188 and inspection by the in-line sensor 190 are carried out in respect of the recording surface.

The halogen heater 186 is controlled to a prescribed temperature (for example, 180° C.). By this means, preliminary heating of the recording medium 124 is carried out.

The fixing roller 188 is a roller member to apply heat and pressure onto the recording medium 124 for applying heat and pressure to the dried ink to melt self-dispersing polymer micro-particles contained in the ink and thereby causing the ink to form a film. More specifically, the fixing roller 188 is disposed so as to press against the fixing drum 184, in such a manner that a nip is created between the fixing roller 188 and the fixing drum 184. By this means, the recording medium 124 is placed between the fixing roller 188 and the fixing drum 184 and is nipped with a prescribed nip pressure (for example, 0.15 MPa), whereby a fixing process is carried out.

The fixing roller 188 is constituted of a heated roller formed by a metal pipe of aluminum, or the like, having good thermal conductivity, which internally incorporates a halogen lamp, and is controlled to a prescribed temperature (for example, 60° C. to 80° C.). By heating the recording medium 124 by means of this heating roller, thermal energy equal to or greater than the Tg temperature (glass transition temperature) of the latex contained in the ink is applied and the latex particles are thereby caused to melt. By this means, fixing is performed by pressing the latex particles into the undulations in the recording medium 124, as well as leveling the undulations in the image surface and obtaining a glossy finish.

In the embodiment shown in FIG. 16, only one fixing roller 188 is arranged, but it is also possible to arrange fixing rollers in a plurality of stages, in accordance with the thickness of the image layer and the Tg characteristics of the latex particles.

The in-line sensor 190 is a reading device for determining an ejection failure checking pattern, the density, and a defect in an image (including a test pattern) recorded on the recording medium 124, and a CCD line sensor or the like is employed for the in-line sensor 190.

According to the fixing unit 120 having the composition described above, the latex particles in the thin image layer formed by the drying unit 118 are heated, pressed and melted by the fixing roller 188, and hence the image layer can be fixed to the recording medium 124.

Instead of the ink which contains a high-boiling-point solvent and polymer micro-particles (thermoplastic resin particles), it is also possible to use an ink containing a monomer which can be polymerized and cured by exposure to ultraviolet (UV) light. In this case, the inkjet printing apparatus 100 includes a UV exposure unit for exposing the ink on the recording medium 124 to UV light, instead of the heat and pressure fixing unit having the heat roller (the fixing roller 188). When using an ink containing an active light-curable resin, such as an ultraviolet-curable resin, the fixing unit 120 is provided with a device which irradiates the active light, such as a UV lamp or an ultraviolet LD (laser diode) array, instead of the fixing roller 188 for heat fixing.

### <Paper Output Unit>

As shown in FIG. 16, the paper output unit 122 is arranged subsequently to the fixing unit 120. The paper output unit 122 includes an output tray 192, and a transfer drum 194, endless conveyance belts 196 and a tensioning roller 198 are arranged between the output tray 192 and the fixing drum 184 of the fixing unit 120 so as to oppose same. The recording medium 124 is sent to the conveyance belts 196 by the transfer drum 194 and output to the output tray 192. The details of the paper conveyance mechanism created by the conveyance belts 196 are not shown, but the leading end portion of the recording medium 124 after printing is held by a gripper on a bar (not shown) which spans between the endless conveyance belts 196, and the recording medium 124 is conveyed about the output tray 192 due to the rotation of the conveyance belts 196.

Furthermore, although not shown in FIG. 16, the inkjet printing apparatus 100 according to the present embodiment includes, in addition to the composition described above, an ink storing and loading unit which supplies the ink to the inkjet heads 172M, 172K, 172C and 172Y, and a device which supplies the treatment liquid to the treatment liquid deposition unit 114, as well as including a head maintenance unit which carries out cleaning (nozzle surface wiping, purging, nozzle suction, and the like) of the inkjet heads 172M, 172K, 172C and 172Y, position determination sensors which determine the position of the recording medium 124 in the paper conveyance path, temperature sensors which measures the temperatures of the respective units of the apparatus, and the like.

### <Description of Control System>

FIG. 17 is a block diagram showing the main configuration of the system of the inkjet printing apparatus 100. The inkjet printing apparatus 100 includes a communication interface 270, a system controller 272, a print controller 274, a head driver 278, a motor driver 280, a heater driver 282, a treatment liquid deposition control unit 284, a drying control unit 286, a fixing control unit 288, a memory 290, a ROM 292, the encoder 294, and the like.

The communication interface 270 is an interface unit for receiving image data sent from a host computer 350. A serial interface such as USB (Universal Serial Bus), IEEE1394, Ethernet, and wireless network, or a parallel interface such as a Centronics interface may be used as the communication interface 270. A buffer memory (not shown) may be mounted in this portion in order to increase the communication speed. The image data sent from the host computer 350 is received by the inkjet printing apparatus 100 through the communication interface 270, and is temporarily stored in the memory 290.

The memory 290 is a storage device for temporarily storing images inputted through the communication interface 270, and data is written and read to and from the memory 290 through the system controller 272. The memory 290 is not limited to a memory composed of semiconductor elements, and a hard disk drive or another magnetic medium may be used.

The system controller 272 is constituted of a central processing unit (CPU) and peripheral circuits thereof, and the like, and it functions as a control device for controlling the whole of the inkjet printing apparatus 100 in accordance with a prescribed program, as well as a calculation device for performing various calculations. More specifically, the system controller 272 controls the various sections, such as the communication interface 270, print controller 274, motor driver 280, heater driver 282, treatment liquid deposition control unit 284 and the like, as well as controlling communications with the host computer 350 and writing and reading to and from the memory 290, and it also generates control signals for controlling the motor 296 and heater 298 of the conveyance system.

The program executed by the CPU of the system controller 272, the various types of data which are required for control procedures, and the like are stored in the ROM 292. The ROM 292 may be a non-writeable storage device, or it may be a rewriteable storage device, such as an EEPROM. The memory 290 is utilized as a temporary storage area of the image data, and also utilized as an expansion area of the program and a calculation operation area of the CPU.

The motor driver 280 is a driver which drives the motor 296 in accordance with instructions from the system controller 272. In FIG. 17, various motors arranged in the respective units of the apparatus are represented by the reference numeral 296. For example, the motor 296 shown in FIG. 17 includes motors which drive the rotation of the paper supply drum 152, the treatment liquid drum 154, the image formation drum 170, the drying drum 176, the fixing drum 184, the transfer drum 194, and the like, shown in FIG. 16, and a drive motor of the pump for producing a negative pressure through the suction holes of the image formation drum 170, a motor of a withdrawal mechanism which moves head units of the inkjet heads 172M, 172K, 172C and 172Y (collectively referred to as a head 250 in FIG. 17) to the maintenance area apart from the image formation drum 170, and the like.

The heater driver 282 is a driver which drives the heater 298 in accordance with instructions from the system controller 272. In FIG. 17, various heaters arranged in the respective units of the apparatus are represented by the reference numeral 298. For example, the heater 298 shown in FIG. 17 includes a pre-heater (not shown) for previously heating the recording medium 124 to a suitable temperature in the paper supply unit 112.

The print controller 274 has a signal processing function for performing various tasks, compensations, and other types of processing for generating print control signals from the image data stored in the memory 290 in accordance with instructions from the system controller 272 so as to supply the generated print data (dot data) to the head driver 278.

In general, the dot data is generated by subjecting the multiple-tone image data to color conversion processing and half-tone processing. The color conversion processing is processing for converting image data represented by an sRGB system, for instance (for example, 8-bit RGB color image data) into image data of the respective colors of ink used by the inkjet printing apparatus 100 (KCMY color data, in the present embodiment).

Half-tone processing is processing for converting the color data of the respective colors generated by the color conversion processing into dot data of the respective colors (KCMY dot data, in the present embodiment) by error diffusion or a threshold matrix method, or the like.

Prescribed signal processing is carried out in the print controller 274, and the ejection amount and the ejection timing of the ink droplets from the head 250 are controlled through the head driver 278, on the basis of the obtained dot data. By this means, prescribed dot size and dot positions can be achieved.

The print controller 274 is provided with an image buffer memory (not shown), and image data, parameters, and other data are temporarily stored in the image buffer memory when image data is processed in the print controller 274. Also possible is a mode in which the print controller 274 and the system controller 272 are integrated to form a single processor.

To give a general description of the sequence of processing from image input to print output, image data to be printed (original image data) is inputted from an external source through the communication interface 270, and is accumulated in the memory 290. At this stage, RGB image data is stored in the memory 290, for example. In the inkjet printing apparatus 100, an image which appears to have a continuous tonal graduation to the human eye is formed by changing the deposition density and the dot size of fine dots created by ink (coloring material), and therefore, it is necessary to convert the input digital image into a dot pattern that reproduces the tonal graduations of the image (namely, the light and shade toning of the image) as faithfully as possible. Therefore, original image data (RGB data) stored in the memory 290 is sent to the print controller 274, through the system controller 272, and is converted to the dot data for each ink color by half-tone processing using a threshold matrix method, an error diffusion method or the like. In other words, the print controller 274 performs processing for converting the input RGB image data into dot data for the four colors of K, C, M and Y. The dot data thus generated by the print controller 274 is stored in the image buffer memory (not shown).

The head driver 278 outputs a drive signal for driving the actuators corresponding to the respective nozzles of the head 250 on the basis of the print data supplied from the print controller 274 (in other words, dot data stored in the image buffer memory). The head driver 278 may also incorporate a feedback control system for maintaining uniform drive conditions in the head 250.

By applying the drive signal output from the head driver 278 to the head 250, ink is ejected from the corresponding nozzles. An image is formed on the recording medium 124 by controlling the ink ejection from the head 250 while conveying the recording medium 124 at a prescribed speed. The inkjet printing apparatus 100 in the present embodiment employs a drive method in which a common drive power waveform signal is applied to the piezoelectric actuators of the head (head modules) 250, in units of one module, and the ink is ejected from the nozzles 251 corresponding to the respective piezoelectric actuators by turning switching elements (not shown) connected to the individual electrodes of the piezoelectric actuators on and off, in accordance with the ejection timing of the respective piezoelectric actuators.

The treatment liquid deposition control unit 284 controls the operation of the treatment liquid application device 156 (see FIG. 16) in accordance with instructions from the system controller 272. The drying control unit 286 controls the operation of the solvent drying device 178 (see FIG. 16) in accordance with instructions from the system controller 272.

The fixing control unit 288 controls the operation of a pressing and fixing unit 299 which is constituted of the halogen heater 186 and the fixing roller 188 (see FIG. 16) of the fixing unit 120 in accordance with instructions from the system controller 272.

As described with reference to FIG. 16, the in-line sensor 190 is the block including the image sensor, which reads in the image printed on the recording medium 124 and performs various signal processing operations and the like so as to determine the print situation (presence/absence of ejection, variation in droplet ejection, optical density, and the like), and these determination results are supplied to the system controller 272 and the print controller 274.

The print controller 274 implements various corrections (such as ejection failure correction and density correction) with respect to the head 250, on the basis of the information obtained from the in-line sensor 190, and it also implements control for carrying out cleaning operations (nozzle restoring operations), such as preliminary ejection, suction, or wiping, as and when necessary.

### Modification Embodiments

In the embodiments described above, the inkjet printing apparatus based on the method which forms an image by ejecting and depositing ink droplets directly onto a recording medium 124 (direct recording method) has been described, but the application of the present invention is not limited to this, and the present invention can also be applied to an image forming apparatus of an intermediate transfer type which forms an image (primary image) at first on an intermediate transfer body, and then performs final image formation by transferring the primary image onto recording paper in a transfer unit.

Furthermore, in the embodiments described above, the inkjet printing apparatus using the page-wide full-line type heads having the nozzle rows of the length corresponding to the full width of the recording medium (i.e., the single-pass image forming apparatus which completes an image by a single sub-scanning action) has been described, but the application of the present invention is not limited to this, and the present invention can also be applied to an inkjet printing apparatus which performs image recording by means of a plurality of scanning actions by moving a short recording head, such as a serial head (shuttle scanning head) or the like, to scan a recording medium.

### <Device for Causing Relative Movement of Head and Paper>

In the embodiments described above, the composition has been exemplified in which the recording medium is conveyed with respect to the stationary heads, but in implementing the present invention, it is also possible to move heads with respect to a stationary recording medium (image formation receiving medium).

### <Applications of the Present Invention>

In the embodiments described above, the application to the inkjet printing apparatus for graphic printing has been described, but the scope of application of the present invention is not limited to this. For example, the present invention can also be applied widely to inkjet systems which obtain various shapes or patterns using liquid function material, such as a wire printing apparatus which forms an image of a wire pattern for an electronic circuit, manufacturing apparatuses for various devices, a resist printing apparatus which uses resin liquid as a functional liquid for ejection, a color filter manufacturing apparatus, a fine structure forming apparatus for forming a fine structure using a material for material deposition, or the like.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid ejection head, comprising:
a plurality of pressure chambers which are each filled with liquids;
a plurality of supply flow channels which are connected respectively to the pressure chambers, the liquids being supplied through the supply flow channels to the pressure chambers;
a plurality of ejection energy generating devices which are arranged correspondingly to the pressure chambers, the ejection energy generating devices being driven by a drive signal to generate ejection force; and
a plurality of ejection ports which are connected respectively to the pressure chambers, the liquids in the pressure chambers being ejected outward through the ejection ports by the ejection force generated by the corresponding ejection energy generating devices, wherein:
the liquid ejection head has a recording element including a set of ejection elements;
each of the ejection elements includes one of the pressure chambers, one of the supply flow channels which is connected to the one of the pressure chambers, one of the ejection energy generating devices which is arranged correspondingly to the one of the pressure chambers, and one of the ejection ports which is connected to the one of the pressure chambers;
the ejection elements constituting the same set have identical ejection operation characteristics;
the ejection energy generating devices included in the ejection elements constituting the same set are connected to a common signal wire, and are configured to be applied with the same drive signal through the common signal wire to be simultaneously driven; and
in the ejection elements constituting the same set, when the ejection energy generating devices are simultaneously driven, the liquids are ejected through the ejection ports and deposited to a same pixel on an image formation medium in an image formation operation.

2. The liquid ejection head as defined in claim 1, wherein the pressure chambers included in the ejection elements constituting the same set are supplied with the liquids having identical composition.

3. The liquid ejection head as defined in claim 1, wherein:
the ejection energy generating devices each include actuators configured to change volume of the corresponding pressure chambers; and
the actuators included in the ejection energy generating devices included in the ejection elements constituting the same set have identical excluding volume.

4. The liquid ejection heads as defined in claim 1, wherein the pressure chambers included in the ejection elements constituting the same set have an identical resonance frequency.

5. The liquid ejection head as defined in claim 1, wherein the pressure chambers included in the ejection elements constituting the same set are connected to each other through a joint flow channel.

6. The liquid ejection head as defined in claim 5, wherein in each of the pressure chambers in plan view, a portion to which the supply flow channel is connected and a portion to which the joint flow channel is connected are arranged at substantially diagonally opposite positions or at positions distanced furthest apart.

7. The liquid ejection head as defined in claim 5, wherein in the ejection elements constituting the same set, at least one of the supply flow channels connected to the pressure chambers is configured to also serve as a circulation flow channel through which the liquids inside the pressure chambers are circulated while no ejection operation is performed.

8. The liquid ejection head as defined in claim 1, wherein in the ejection elements constituting the same set, at least two of the ejection ports are arranged side by side along a direction parallel to a relative movement direction in which the liquid ejection head and the image formation medium are moved relatively to each other during the image formation operation.

9. The liquid ejection head as defined in claim 1, wherein each of the ejection ports has one of a circular shape, an elliptical shape, a semi-circular shape, a semi-elliptical shape obtained by cutting an ellipse along a minor axis thereof, and a quadrilateral shape.

10. The liquid ejection head as defined in claim 1, wherein meniscuses of the liquids are formed respectively in the ejection ports.

11. The liquid ejection head as defined in claim 1, wherein:
the recording element further includes a nozzle section;
the ejection ports included in the ejection elements constituting the same set are arranged inside the same nozzle section; and
in the ejection elements constituting the same set, when the ejection energy generating devices are simultaneously driven, droplets of the liquids are ejected through the ejection ports and then combine together in the same nozzle section to be ejected outward through the same nozzle section as a combined droplet.

12. The liquid ejection head as defined in claim 1, wherein in the ejection elements constituting the same set, when the ejection energy generating devices are simultaneously driven, the liquids are ejected outward through the ejection ports, then combine together before arriving at the image formation medium, and then land on the image formation medium.

13. The liquid ejection head as defined in claim 1, wherein in the ejection elements constituting the same set:
a number of the ejection elements is two; and
an arrangement of the two ejection elements is one of mirror symmetrical and rotationally symmetrical.

14. The liquid ejection head as defined in claim 1, wherein in the ejection elements constituting the same set:
a number of the ejection elements is at least three; and
an arrangement of the at least three ejection elements is rotationally symmetrical.

15. The liquid ejection head as defined in claim 1, wherein in the ejection elements constituting the same set:
a number of the ejection elements is an even number not less than four;
an arrangement of at least two of the ejection elements is rotationally symmetrical; and
an arrangement of at least two of the ejection elements is mirror symmetrical.

16. The liquid ejection head as defined in claim 1, wherein:
the recording element further includes a partition member across which two of the pressure chambers included in the ejection elements constituting the same set adjoin each other; and
at least portion of the partition member is configured to deform when the ejection force is applied by at least one of the ejection energy generating devices corresponding to the two of the pressure chambers.

17. The liquid ejection head as defined in claim 16, wherein the at least portion of the partition member has a pleat-shaped bent section.

18. The liquid ejection head as defined in claim 1, wherein:
the ejection energy generating devices each include actuators having piezoelectric bodies; and
the piezoelectric bodies are divided from each other for the pressure chambers.

19. The liquid ejection head as defined in claim 1, wherein:
the ejection energy generating devices each include actuators having piezoelectric bodies; and
the piezoelectric bodies of the actuators included in the ejection elements constituting the same set are connected to each other.

20. The liquid ejection head as defined in claim 1, wherein a flow channel part including the pressure chambers and the supply flow channels is formed in a silicon substrate.

21. A liquid ejection apparatus, comprising:
the liquid ejection head as defined in claim 1; and
a drive control circuit which controls an ejection operation of the liquid ejection head by generating the drive signal applied to each of the ejection energy generating devices,
wherein a waveform of the drive signal is configured to accelerate a speed of flight of a satellite droplet compared to a speed of flight of a main droplet in such a manner that the satellite droplet and the main droplet combine together during the flight, the main droplet being formed of the liquid ejected first by an ejection operation, the satellite droplet being formed of the liquid ejected following the liquid forming the main droplet.

22. The liquid ejection apparatus as defined in claim 21, wherein the waveform of the drive signal has a waveform element configured to drive each of the ejection energy generating devices in a direction to push out the liquid when the liquid that is separated from a meniscus as the satellite droplet passes near the ejection ports.

23. An inkjet printing apparatus which uses the liquid ejection head as defined in claim 1.

24. An inkjet printing apparatus which uses the liquid ejection apparatus as defined in claim 21.
